(19) United States
(12) Patent Application Publication
(10) Pub. No.: US 2006/0031473 A1
(43) Pub. Date: Feb. 9, 2006

(54) System and method for high capacity fault correlation

(76) Inventor: John A. Wood, Alpharetta, GA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/886,833

(22) Filed: Jul. 7, 2004

(51) Int. Cl. G06F 15/173

(52) U.S. Cl. 709/224

(57) ABSTRACT

A system and method for high capacity fault correlation is disclosed, employing rapid indication of the relevancy of a received transaction (new, create, update description alarm) to correlations being run on a manager of managers in a large communications (data, wireline, wireless) to avoid unnecessary correlation processing.

### BACKGROUND OF THE INVENTION

Network management systems (NMS's) and Managers of managers (MOMs) are now in wide use for the purpose of facilitating administration, configuration, and monitoring of large, complex wireless, wireline and data networks, including 2.5G. 3G, GSM, GPRS, optical, fix voice, NgN, VoP and IP. Some NMS's such as, for example, Agilent's Operational Support System (OSS) suite of network management and service assurance (NETeXPERT™) and revenue assurance solutions are implemented using object-oriented computer programming development environments. In these systems, it is convenient to represent physical elements of a real-world network, such as routers, switches, and their components, in terms of programmatic objects and instances of the objects. Physical managed objects are resources that are defined by physical hardware components. Examples of physical managed objects that are useful in representing a telecommunication network include nodes, cards, ports, and trunks. Logical managed objects, in contrast, are supported by one or more hardware components. Examples of logical managed objects include end-to-end user connections, and endpoints of user connections.

Large telecommunications networks are subject to occasional and/or frequent faults, which result in alarms being raised. Fault alarm incidents (or messages) are routinely generated for the various components of a network to allow the service provider to monitor the operational state of the network. Fault management systems generally receive and process these alarm incidents in accordance with fault management objectives as defined by the service provider.

In communication networks, network management systems (NMS) are provided to monitor events in the network. A single network fault may generate a large number of alarms over space and time. In large, complex networks, simultaneous network faults may occur, causing the network operator to be flooded with a high volume of alarms. The high volume of alarms greatly inhibits the ability of an operator of a NMS to identify and locate the responsible network faults.

A high capacity NMS is required to handle on the order of 1 million alert transactions per day, in addition to maintaining approximately 20,000-40,000 outstanding or unresolved alerts. Each alert that is created, updated or cleared by the NMS has the possibility of affecting other alerts that may be tightly or loosely associated or correlated. The ability to receive each alert “add”, “update” or “clear” transaction and evaluate it individually requires excessive time and computational resources, and is almost impossible. Accordingly, it is desirable that the NMS's central monitoring system, or operator, normally only receives a stream of relatively high level alerts that have been correlated from subordinate alerts.

A few examples of alarm correlation is the process by which several alarms are narrowed from a mass of problems to a root cause or to suppress subordinate alerts when a superior alert is present. Alarm correlation systems are known and employed for reducing the resources required to process all active network alerts in conjunction with the large volume of transactions, however, attempts to fully process a high volume of individual alert transactions is practically impossible and result in inherently slow operation. Service providers who need to manage large networks are constantly seeking solutions that will remove the cost and complexity from monitoring their networks while maintaining an acceptable level of performance.

In order to overcome the disadvantages of existing solutions, it would be advantageous to have a system and method of correlating large numbers of network alarms to reduce the resources requirements. The present invention provides such a system and method, and does so with near real-time alarm correlation.

### SUMMARY OF THE INVENTION

The invention provides a high capacity fault correlation system and method for rapidly identifying and qualifying that alerts received from alert collection points in a network by a network manager of managers (MOM) system are valid for correlation processing, and then reducing in real-time the number of alerts that each correlation evaluation by the MOM must process.

The system includes a correlation system communicatively connected to a network for receiving alert transactions from the network. The system employs selection criterion to be used to validate or interrogate a large volume of active alerts, in order to identify a subset of alerts that are relevant to each active correlation on the system. The selection criteria are based on information related to the alert transaction such as, for example, point of origin information. Alerts determined to be irrelevant alerts are not processed any further by a correlation action, rather they are passed back into the normal alarm processing that the system provides. The correlation system processes all ‘create’, ‘clear’ and selected ‘update’ alert transactions. Once an alert is determined to be a candidate for correlation processing by the first validation process, the subset of correlations associated with that alert is known as a result of the items matched during the first validation. Subsequent correlation processing involves only the candidate alert and the extracted list of correlations known to be associated with the candidate, rather than applying all the active correlations to all the incoming alert transactions. A second “spot checking” validation process involves determining if the candidate alert transaction matches any of the extracted correlations' matching criteria. Only if a candidate alert transaction results in matches during the “spot checking” will the fuill correlation be evaluated using all relevant alerts related to that correlation which are stored in memory and associated to the particular correlation.

The system allows utilization of “regular expressions” to locate or match a criterion, rather than requiring an exact name match. This improves overall speed, efficiency and flexibility. In another aspect, the invention allows correlations to be tested before they are activated, logging their test results during a testing mode without actually performing a correlation that might affect an accurate reflection of the network state at a given point in time. The system allows underlying subordinate alerts that are ‘hidden’ from view as a result of a correlation to be actively processed independently instead of being discarded or suppressed.

### BRIEF DESCRIPTION OF THE FIGURES OF THE DRAWING

For a better understanding of the present invention, together with other and further objects thereof, reference is made to the accompanying figures and detailed description, wherein:

FIG. 1 is a functional depiction of the conceptual TMN relationship between a management system and the managed network;

FIG. 2 shows a logical functional diagram of a TMN-based management system;

FIG. 3 diagrammatically shows the various TMN management layers;

FIG. 4 diagrammatically shows a hierarchical architecture employed in an embodiment of the present invention;

FIG. 5 is a flow diagram illustrating the correlation system initialization process; and

FIG. 6 is a flow diagram illustrating the correlation processing of a new alarm transaction.

### DETAILED DESCRIPTION OF PREFERRED EMBODIMENTS OF THE INVENTION

The foregoing has outlined rather broadly the high capacity fault correlation system (HCFCS) and correlation method of the present invention. Embodiments of the present invention will now be described in the context of a network management hierarchy employing NetExpert/VSM™ platform and NetExpert's Peer to Peer product (P2P) owned by Agilent Technology, the assignee of the present invention. The invention is described as generally as possible; however, a brief discussion of certain features and/or terminology inherent to NetExpert is provided. Those skilled in the art will readily appreciate that the concepts and specific embodiments disclosed may be utilized as a basis for modifying or designing other structures on other platforms for carrying out the same purposes of the present invention.

A. Overview

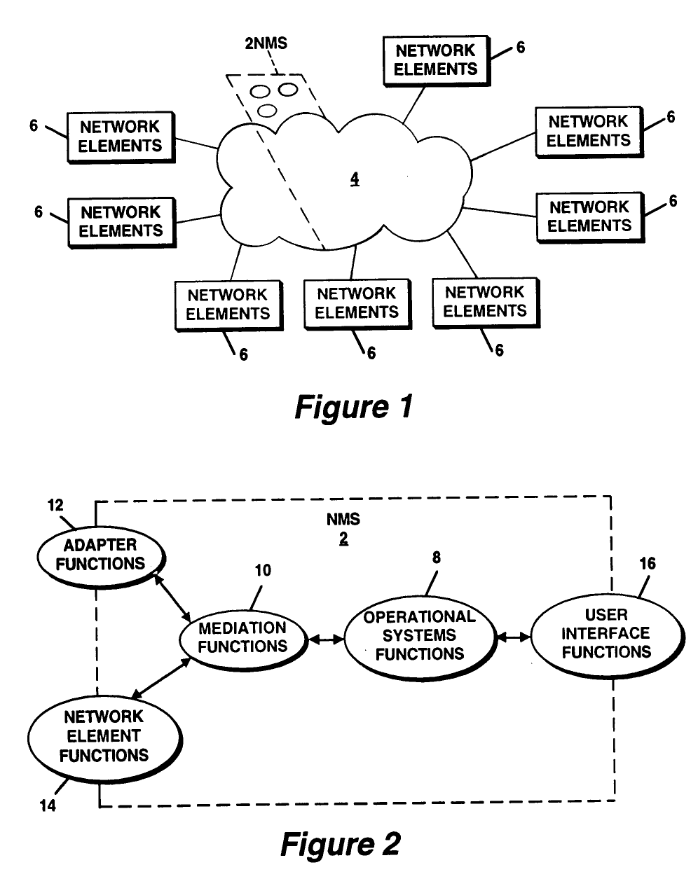

One embodiment of the present invention operates in connection with an operations support systems (OSS) framework for managing networks and network services that are provided to customers. The OSS NetExpert framework is based on the standard Telecommunication Network Management (TMN) architecture promulgated by the International Telecommunications Union. FIG. 1 functionally depicts the conceptual TMN relationship between OSS 2 and the managed network 4, which includes network elements 6. FIG. 1 illustrates the oversight nature of OSS 2. Network elements 6 correspond to the physical modules and systems (e.g., switches, termination points, databases, sub-networks) that are “managed” by OSS 2. One of the aspects of the TMN paradigm is that it promotes inter-operability between different components, systems, and networks within the managed “network” 4, regardless of their particular configurations and protocols.

FIG. 2 shows a logical functional diagram of an OSS 2 consistent with the TMN standard. OSS 2 includes operational systems functions 8, mediation functions 10, adaptor functions 12, network element functions 14, and user interface functions 16. Mediation functions 10 communicatively link operational systems functions 8, adaptor functions 12, and network element functions 14 between one another. User interface functions 16 are linked to operational systems functions 8.

Operations systems functions 8 correspond to functions that manage the OSS. It performs various activities including obtaining management information such as acquiring alarm information from managed network elements, performing the required information processing activities on the network (e.g., correlating alarms, implementing service requests), and directing the managed elements to take appropriate action such as performing a test. Network element functions 14 correspond to the actual physical elements that make up the network 4.

Alerts (comprising information packets) corresponding to the actual managed network elements are provided to the operations systems functions 8 via the mediation functions 10 in various manners. Some network elements (e.g., a switch) may generate and transmit it's own incidents while others (e.g., a router or circuitpack) may be managed by an element manager, which generates and transmits the incidents for its managed elements. Finally, the user interface functions 16 provide to human users access to the operational Hi systems functions 8. Note that the adaptor, network element, and user interface functions are represented as being partially in and out of the OSS 2 because they are part of the system, but they also interface with the real physical world.

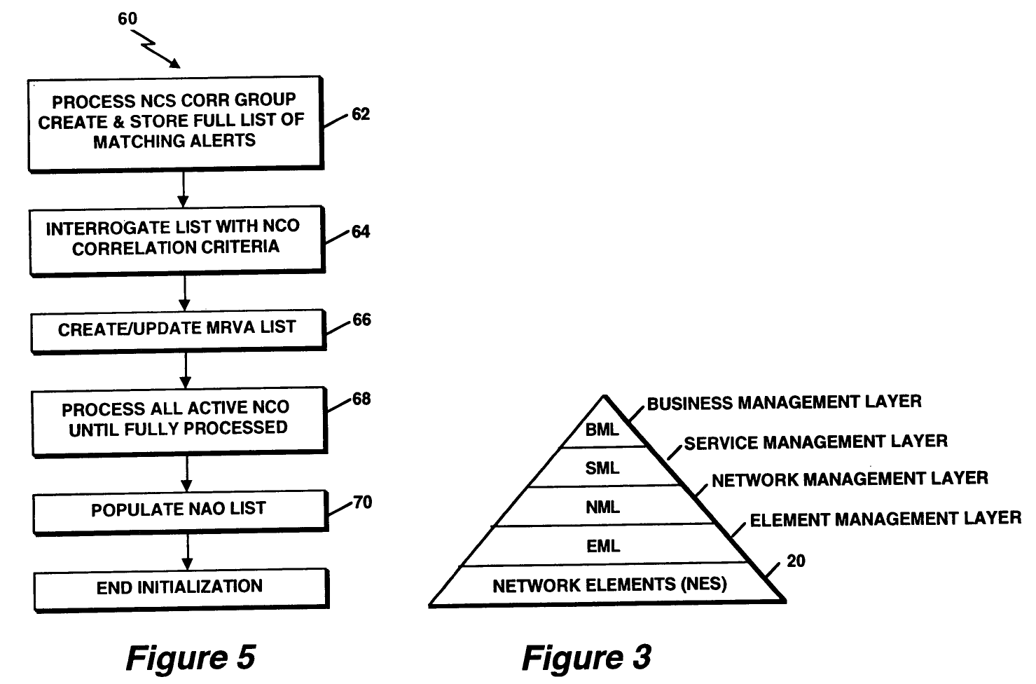

FIG. 3 presents a simplified, hierarchical view of a network consistent with the operating environment of the present invention. Managed network elements (or network elements) 20 correspond to the various elements and associated element managers of the managed network. (The Manager/Network Element blocks 20 correspond to the network elements functions 14 and network elements 6 from FIGS. 2 and 1, respectively.) Each managed element provides (either directly or through an element manager 20) a transaction alert that includes pertinent information about a particular element. For example, a transaction alert for a switch could be an alarm (the terms alarm and alert are used interchangeably herein) that identifies the switch and indicates that some portion thereof has failed.

Each gateway is capable of performing basic processing tasks. In one embodiment, configuration objects, which include both control and scenario objects, are initiated and executed for performing management functions. The gateway, with its processing capability, selects and at least partially processes an initial control object in response to a received alert. In this manner, processing is more efficiently distributed between the management processor system 28 (which include the correlation system) and the gateway rather than exclusively occurring in the management processor system 28, which may be implemented with a centralized server.

Among the processing tasks of the management processor system 28 are fault processing and fault correlation. The management processor system 28 may be implemented on one or more connected servers, and fault processor 30 and correlation processor 32 within the management processor system 28 may be physically, as well as conceptually, distinct from one another.

A network model objects section 36 in resident memory 34 stores network model objects, which are objects that correspond to the managed elements of the network. (It should be noted that these managed elements can exist in any management layer and not simply the element layer.) These element objects contain attributes that reflect the state of the actual, physical element. Thus, the entirety of element objects within this section (for each of the management layers) model the network and enable the management processor system 28 to track and model the state of the managed network. (It should be recognized, however, that various embodiments of the present invention may not use or require complete or even partial network models.)

Within the context of this general network management system, the high capacity fault correlation system of the present invention will now be described.

B. HCFC System Framework

As noted above, management processing systems for large, complex, high traffic networks need to efficiently and flexibly process 1 million or more alarm transactions (e.g., new, clear, update description, etc.) per day, in addition to maintaining a high volume (e.g., in excess of 10,000) of outstanding alerts. Correlation processor 32 optimizes the ability to efficiently identify and process incoming alarm traffic that is relevant to user-defined alarm correlations. Alarm correlations are designed to provide multiple results, which include: creation of root cause alarms and the ‘hiding’ of supporting alarms from a user interface alarm display; identifying “Superior” Alarms and ‘hiding’ “Subordinate Alarms” while the Superior Alarm is present; and, generally, reducing the number of alerts visible to operators upon the User Interface Alarm Display that displays the alarms within the Fault Management System.

National Fault Correlation Model

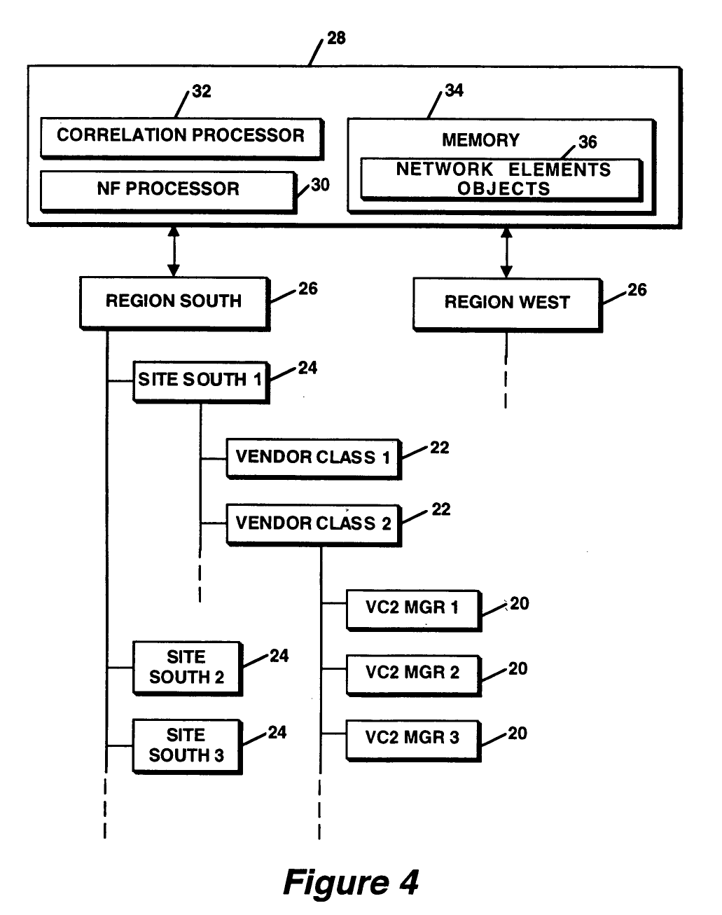

The description of a preferred embodiment that follows is directed to a correlation system that has been developed to specifically manage correlations on a regional (logical or physical) basis for a telecommunications services provider through a centralized national Manager of Managers (MOM). The overall system is comprised of a NetExpert system as the MOM, supported by subordinate NetExpert systems, and providing a National or Overall view of all alarms present upon the subordinate systems. Referring again to FIG. 4, the subordinate systems are logically grouped into Regional Systems 26, each of which contain one or more physical subordinate Site Systems 24.

The Site Systems 24 receive alarm data collected from network elements either directly or through Managers 20. The Site Systems process the collected raw alarm data into NetExpert alerts and forward the alarm data via Peer-to-Peer up to the National Fault System (NFS) processor 30. Thus, the network layer representation of the alarm data flow comprises
National←Regional←Site
Physical←logical←Physical
   and all alarms that are present at the Site Systems 24 are exactly reproduced at the NFS processor 30. (It should be noted that some object details are moved or stored in auxiliary locations, but for all practical purposes the alerts appear identical.) The NFS processor 30 has the ability to process in excess of 1 million transactions (alerts) from multiple Site Systems 24 while maintaining correlations of a large (20,000-40,000) volume of outstanding/active alerts utilizing the method described below. Each alert that is created or cleared by the NFS processor 30 has the potential of effecting a correlation.

Correlations upon the NFS processor 30 utilize custom Managed Objects that are similar to FM Control Objects in certain ways. A National Correlation Object (NCO) will be created and populated for each unique correlation that is to be monitored on the national system, and a unique Correlation Managed Object (CMO) is created and populated for each unique correlation that is to be run upon the HCFC system. The CMO's contain two basic categories of data/information:
1. data that is used to identify alarm(s) that are relevant to the NCO.
2. data that is used to identify the valid origin of alarm(s) that may be relevant to the NCO.

A variety of correlation categories are supportable by the architecture. The following two basic categories (i.e., pattern matches, and superior/subordinate matching) of correlations currently designed for use within the HCFC system are provided by way of example. The system is not limited to these two categories but in fact will allow numerous additional correlation categories to be added as desired. The aforementioned ‘hiding’ of alarms in the following sections is achieved by marking or tagging the alarm with an attribute that will allow the user Alarm Display to refrain from displaying that entry to the user, although the alert will still exist within the system as a valid entity. The two designed correlation categories are defined as:
1. PATTERN Match correlations.
   a. INCLUDE list of alarm(s) that must exists.
   b. EXCLUDE list of alarm(s) that must NOT exists.
   c. Designated CORRELATION Alarm to generate if PATTERN Match is positive or to remove if PATTERN Match is negative.
      i. If the PATTERN Match is positive and the Designated CORRELATION Alarm is created, any existing INCLUDE alarm(s) will be ‘hidden’.
      ii. If the PATTERN Match is positive and the Designated CORRELATION Alarm is present and the alarm identified is within the INCLUDE list of alarms, the alarm will be created but marked to be ‘hidden’.
      iii. If the PATTERN Match is negative and the Designated CORRELATION Alarm is cleared, any existing INCLUDE alarm(s) will be ‘unhidden’
2. SUPERSUB (Superior Subordinate) Match correlations.
   a. List of SUPERIOR Alarm(s) that if present will cause all defined SUBORDINATE Alarm(s) to be ‘hidden’.
   b. List of SUBORDINATE Alarm(s) that will be ‘hidden’ if the defined SUPERIOR Alarm(s) is present.

The entries that are added into the list of alarm(s) within a CMO are regular expressions that may be used to identify an alarm (through internal matching criterion applied to the alarm's context) by any or all of the following fields:
AMO, Affected Managed Object (Device assigned to this alarm)
Alarm Name
Alarm Description

The identification of Alarms that participate in a given correlation is achieved by the use of regular expressions. These regular expressions are built in accordance with the following criteria.
If one wishes to only match on AMO, the regular expression should be something like “ˆAMOName+++”.
If one wishes to only match on AlarmName, the regular expression should be something like “+++AlarmName+++”.
If one wishes to only match on AlarmDescription, the regular expression should be something like “+++AlarmDescription$”.
If one wishes to match on the given string within any field, the regular expression should be something like “matchThis”.

The examples below use single alpha representations to depict an alarm list.
PS PATTERN Match (A & B & C & !D=CORRELATED ALARM)
(If A & B & C exists and D does not; Create CORRELATED ALARM and hide A, B & C)
(If A & B & C do not exists and/or D does exist; Clear CORRELATED ALARM if it is present and un-hide A, B & C.)
SUPERSUB Match (A & B=hide D, E, F, G)
(If A & B exists; hide D, E, F and G)
(If A or B does not exists; un-hide D, E, F and G)

Regular expressions are entered as line item data into the CMOs and utilized as the search criteria into this array of composite strings. Each regular expression must be capable of locating at least one alarm match in order to be a positive result. Each entry within the list may locate multiple alarm matches, which will all be included in the designed actions to be taken by the defined correlation. Multiple matches on a single regular expression are gathered and treated as a positive for that single line item.

The ‘Hiding’ of a correlated alert will be achieved by updating a new Extended Alert Attribute ‘NCSHiddenBy’ with a non-blank value.

A key concept of the present invention is the requirement of the NCO to contain data that qualifies the valid origin of alerts that are relevant to the NCO. The entries that are used to describe the origin of a valid alert are based upon the following hierarchy and contain the following data types. The relational hierarchy described in the next section is not limited in its scope and may be expanded to represent other network hierarchies.

Network Hierarchy

Reference is made again to FIG. 4. Within the Network, a logical REGION 26 contains physical SITE systems 24. SITE systems 24 contain MANAGER CLASSES 22 that are used to represent a managed device classification. These MANAGER CLASSES contain individual MANAGERs 20 that are used to obtain raw alarm data from device entities, which may be an EMS, OSS, COMPOSITE SYSTEMS or an individual DEVICE (not shown.)

Each REGION 26 includes one or more related SITE systems 24. Each MANAGER CLASS 22 should contain one or more related MANAGERs 22. MANAGER CLASSES 22 may be replicated across multiple SITE systems 24. Multiple MANAGERs 20 may exists for each given MANAGER CLASS 22.

For example, a south REGION may be organized as follows:
REGION south
SITE south1, south2, south3, . . .
MANAGER CLASSES VendorClass1, VendorClass2, VendorClass3, . . .
MANAGERS VC1Mgr1, VC1Mgr2, VC2Mgr1, VC3Mgr2, . . .

The data entries stored within each CMO used to describe the valid points of origin for alarms must contain the following entries:
A Valid REGION or a Valid SITE
In conjunction with
A Valid MANAGER CLASS or a valid MANAGER

Presented here is another depiction of the structure utilized to contain this data. NCSCorrGroup is the top of the structure, which contains multiple NCSCorrEntry entries. Each NCSCorrEntry contains the data outlined above.
NCSCorrGroup (type SequenceOf NCSCorrEntry)
   NCSCorrEntry (type Sequence)
      Location (Site or Region)
      NCSCorrMgrClassList (type SequenceOfStrings)
         Contains all Manager Classes that are valid for this correlation.
      NCSCorrMgrList (type SequenceOfStrings)
         Contains all Managers that are valid for this correlation.

CMOs are created using the following containedIn relationships: (Class.MO)
NCSCorrelation.NCSCorrelationTOP
   NCSSuperSubCorrelation.NCSSuperSubTOP
      NCSSuperSubCorrelation.SuperSub CMO 1
      NCSSuperSubCorrelation.SuperSub CMO 2
      NCSSuperSubCorrelation.SuperSub CMO n
   NCSPatterCMOrrelation.NCSPatternTOP
      NCSPatterCMOrrelation.Pattern CMO 1
      NCSPatterCMOrrelation.Pattern CMO 2
      NCSPatterCMOrrelation.Pattern CMO n

HCFC System Initialization & Selective Alert Processing

The CMOs are designed to contain the correlation criteria along with a relationship structure that limits the alerts that are valid and interrogated in order to process a selective groups of alerts and not all alerts.

Reference is made to FIG. 5 to assist in understanding the startup process 60 of the NFS processor. At startup, and at defined intervals, each active NCO will be executed to perform a full interrogation of all extant alerts that have been designated as valid for that NCO.

NCO Full Processing Pseudocode:

In step 62, the NFS processor takes the NCSCorrGroup, whose entries contain all the valid origin for alerts. A full list of all alerts that meet the selection criteria is created and stored for this NCO using these entries. This may be a large list of alarms, since its only criterion is the point of origin for the alert(s).

The next step 64 involves interrogating the full list of alerts against each entry within the NCO correlation criteria (regular expression entries.) As matches are found for a regular expression (step 66), the corresponding NCO entry is marked as a positive result and the alarm that was identified/matched is saved into a new list, the MEMORY RESIDENT VALID ALARM (MRVA list), that contains all alarms that meet any criterion utilized by the NCO. This represents a key concept of the present invention, as, upon completion of the NCO processing, this general list of alerts is saved in active memory and associated to this NCO. This MRVA list contains only the alerts that are valid for this NCO. Thus, re-interrogation of all the active alerts upon the system is not required. Henceforth, when alerts transactions are directed to execute this NCO, the MRVA list of alerts will be utilized and maintained with the appropriate alarm action (i.e., Create/Update/Clear.)

As each entry of the NCO is evaluated, the overall positive or negative result of the NCO is established. Based upon this outcome, alerts may be created, cleared, hidden or un-hidden as described in an earlier section.

In step 68, each additional active NCO is processed until a determination is made that all active NCO's have been fully processed. If all the active NCO's have been fully processed, then in step 70 a new data structure, the NORMALIZED ALARM ORIGIN LIST is populated. This is also an important concept to this embodiment of the present invention. The NORMALIZED ALARM ORIGIN LIST is created by taking the NCSCorrGroup from each NCO and creating a Normalized list of these criterion. In other words, this list will contain non-duplicated entries that describe all valid origin points for alerts that may affect active NCOs. Each entry within this structure will contain the NCSCorrEntry as described earlier along with a list of each NCO that utilized this unique NCSCorrEntry. This results in a normalized group of alarm origin criteria that not only allows an alarm's unique point of origin to be evaluated, but also provides the list of NCOs that are associated with that point of origin. There may be multiple NCOs on a system but this list allows only the NCOs that are necessary to be evaluated.

D. Transaction Processing after Initial Setup

In the previous section, system initialization resulted in the population of a NCO specific MEMORY RESIDENT VALID ALARM LIST and a System NORMALIZED ALARM ORIGIN LIST. During operation thereafter, processing is only performed for transactions comprising NEW alarms, CLEARING alarms, and UPDATES that effect an alarm's DESCRIPTION. All other types of alarm updates or modifications are ignored by the NFS processor 30 and are simply processed by conventional/existing fault system processing.

New Alarms

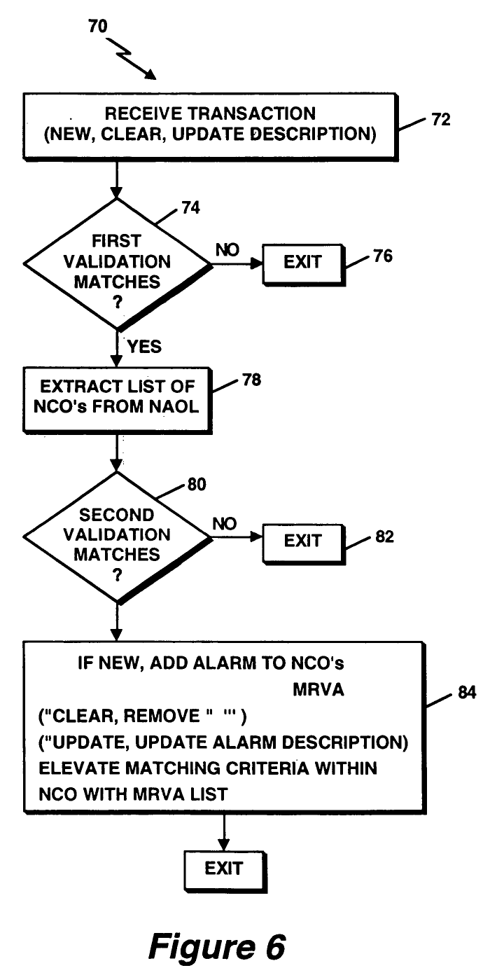

Reference is made to FIG. 6, which illustrates a method 70 for routine processing of NEW alarms after initial system setup.

In step 72, the transaction (NEW alert) is received at the NFS processor 30.

In step 74, a first level validation is performed against the NEW alarm. The alarm is interrogated against the NORMALIZED ALARM ORIGIN LIST. If the point of origin for the alarm does not match any entries within the NAO list, the alarm is ignored by the correlation system and is processed by the normal fault system (represented as step 76, wherein processing of the alarm exits from method 70). It is important to note here that ‘points of origin’ have been chosen as selection criteria because of the perceived value of this type of partitioning, however the present invention is not limited to this choice of criterion in its first level validation design.

In step 78, if the alert does match an entry in the NAO list, the associated list of NCOs is extracted. Note that the alarm and its data will be processed only for each of the extracted NCO's, rather than all the NCO's in the system. This results in a significant reduction in require processing resources and cost.

In step 80, a second level validation is run, wherein a ‘Spot Check’ is performed against the NCO. This process involves validating the alert against the entire criterion utilized within the NCO. Each regular expression is evaluated against the alert to see if a match is located. Checking of each criterion proceeds until a match is located, then the checking terminates since a single match is all that is needed to make this test return a positive result. If no match is located within any of the criterion, further correlation processing of the NEW alarm is not required and processing exits process 70 in step 82.

If the alert matches any criterion within the NCO, it has the opportunity to affect the NCO results. If a positive result is obtained from the second level validation, a number of actions occur (step 84.) First, as the alert consists of a NEW alert, the alert is added to the NCO's MEMORY RESIDENT VALID ALARM LIST. Utilizing the NCO's MEMORY RESIDENT VALID ALARM LIST, the matching criteria within the NCO are evaluated and a positive or negative result is determined for this NCO. The results of the correlation may then be used by other routines of the HCFC system (e.g., changing the operator's visual user interface. It is worth repeating here that the list of alarms that are processed by the NCO is the MEMORY RESIDENT VALID ALARM LIST. This list contains all the NCO-relevant alerts identified, and therefore it is not necessary to gather or search the entire system for relevant alarms. This list of relevant alerts is memory resident and will be substantially smaller that interrogating the full list of alerts active within the fault system.

Clearing Alarms

The processing of CLEAR alarm transactions is quite similar to that of NEW alarms, so only key differences will be discussed here. The receipt and first level validation of clearing alarms is performed in the same manner as for new alarms, and an associated list of NCO's is similarly extracted upon alert/entry matching.

During the second level validation, the ‘Spot Check’ is performed against the NCO's MEMORY RESIDENT VALID ALARM LIST to determine whether the alarm exists within this list. This list contains all alarms that are relevant to the NCO, so if the alarm is not located within the list, it is not relevant to this NCO and processing exits the HCFC system. If the alert is found, it has an opportunity to affect the NCO results. In this case, the alert is removed from the NCO's MEMORY RESIDENT VALID ALARM LIST because the transaction consists of a CLEAR alarm. Then employing the NCO's MEMORY RESIDENT VALID ALARM LIST, the matching criteria Within the NCO are evaluated and a positive or negative result is determined for this NCO. Again, the present invention saves resources in that rapid identification of relevant alarms makes it unnecessary to gather or search the entire system for relevant alarms. This list of relevant alerts is memory resident and will be substantially smaller that interrogating the full list of alerts active within the fault system.

Description Update Alarms

The processing of DESCRIPTION UPDATE alarm transactions is quite similar to those of the new and clear alarm transaction, and similarly benefits from rapid relevancy identification. If, and only if, the alarm is found in the MRVA list during spot-checking in the second level validation, then the alert description is updated within the MRVA list.

E. Additional Functions for Netexpert/VSM Correlation Systems

The following CMOs may be added, updated and deleted via a FIFO (first in first out) gateway or via a custom Java User Interface. The contents of these objects may be printed via a custom CARS (Command and Response System) event that will produce an output format that is also the input format for the FIFO. Printing of the CMOs may be selectively processed. Changes processed via the FIFO will be real-time and take place into a running system.

CMOs make use of an attribute named ‘operationalState’ which may be set to the following values, which will produce the following results.
active
   CMO is active/live and will be processed if requested. Debug output will be created upon each execution to indicate correlation processing and results.
disabled
   CMO is disabled and will not be processed if requested. A short Debug output will be created to show this execution was denied.
enabled
   CMO is enabled/testing and in test mode, which will produce full debug log of the correlation process but no alerts actions will be processed. (TEST MODE)

A custom CARS event is available which may be used to invoke a Correlation Event. The CMOs are created using containment which will allow the following flexibility in requesting executions:
ALL PATTERN and SUPERSUB correlations
PATTERN correlations only
SUPERSUB correlations only
Individual CMO correlation

New NCS Correlation Classes created within the NCS:
NCSCorrelation
   NCSSuperSubCorrelation
   NCSPatterCMOrrelation

New CMOs created and relationships built/required within the NCS:
NCSCorrelation.NCSCorrelationTOP
   contains
   NCSSuperSubCorrelation.NCSSuperSubTOP
      contains all Super/Sub Objects (User defined)
      SuperSubNCO1
      SuperSubNCO2
      SuperSubNCOn
   contains
   NCSPatterCMOrrelation.NCSPatternTOP
      contains all Pattern Objects (User defined)
      PatternNCO1
      PatternNCO2
      PatternNCOn

Pattern Match

Below is an example of a Class Definition for NCSPatterCMOrrelation along with sample data and an example of an actual CMO data printout and loading file.

CLASS: NCSPatterCMOrrelation

PatterCMOrrelationSample (Pattern Correlation MO)
operationalStatus (type enum) enable, disable, active
NCSCorrelationGenerate (type NCSAlertlnstance)
   mo
   name
   description
   severity
NCSCorrelationInclude (type SequenceO<Strings)
   Contains all desired Regular Expressions to be matched as include.
NCSCorrelationExclude (type SequenceOfStrings)
   Contains all desired Regular Expressions to be matched as exclude.
NCSCorrGroup (type SequenceOf NCSCorrEntry)
   NCSCorrEntry (type Sequence)
      Location (Site or Region)
      NCSCorrMgrClassList (type SequenceOfStrings)
         Contains all Manager Classes that are valid for this correlation.
      NCSCorrMgrList (type SequenceOfStrings)
         Contains all Managers that are valid for this correlation.

Note that data entry validation or post validation needs to be taken to assure that a Manager and its associated Manager Class are not entered within the same entry item. The routine will handle this situation by performing a unique sort of the results but this will cause extra work to occur if allowed.

Pattern MO Example showing attributes and values:
operationalStatus enabled
NCSCorrelationGenerate.mo ROOT-CAUSE-OBJECT
NCSCorrelationGenerate.name CorrelatedAlert
NCSCorrelationGenerate.description Call Field Engineer
NCSCoreelationGenerate.severity critical
NCSCorrelationInclude[0] TOWER FAILURE
NCSCorrelationInclude[1] CELL FAULT
NCSCorrGroup
   NCSCorrEntry[0].Location south (a Region)
   NCSCorrEntry[0].NCSCorrMgrClassList MGRCLASS-A
   NCSCorrEntry[1].Location northl (a Site)
   NCSCorrEntry[1].NCSCorrMgrList FM_GW_{—}1
   NCSCorrEntry[1].NCSCorrMgrList FM_GW_{—}3
   NCSCorrEntry[1].NCSCorrMgrList FM_GW_{—}5
   NCSCorrEntry[2].Location east2 (a Site)
   NCSCorrEntry[2].NCSCorrMgrList FM_GW_{—}2
   NCSCorrEntry[2].NCSCorrMgrList FM_GW_{—}4
   NCSCorrEntry[2].NCSCorrMgrList FM_GW_{—}6

SuperSub Match

Example of the Class Definition for NCSSuperSubCorrelation along with sample data and an example of an actual Correlation Object data printout and loading file:

CLASS: NCSSuperSubCorrelation

SuperSubCorrelationSample (Pattern Correlation MO)
operationalStatus (type enum) enable, disable, active
NCSCorrelationSuper (type SequenceOfStrings)
   Contains all desired Regular Expressions to be matched as SUPER.
NCSCorrelationSub (type SequenceOfStrings)
   Contains all desired Regular Expressions to be matched as SUB.
NCSCorrGroup (type Sequenceof NCSCorrEntry)
   NCSCorrEntry (type Sequence)
      Site (Site or Region)
      NCSCorrMgrClassList (type SequenceOfStrings)
         Contains all Manager Classes that are valid for this correlation.
      NCSCorrMgrList (type SequenceOfStrings)
         Contains all Managers that are valid for this correlation.

SuperSub MO Example showing attributes and values:
operationalStatus enabled
NCSCorrelationSuper[0] T1_Failure
NCSCorrelationSub[0] DS0_Failed
NCSCorrelationSub[1] DS0_Warning
NCSCorrelationSub[2] DS0_Fault
NCSCorrGroup
   NCSCorrEntry[0].Location south (a Region)
   NCSCorrEntry[0].NCSCorrMgrClassList MGRCLASS-B
   NCSCorrEntry[1]. Location northl (a Site)
   NCSCorrEntry[1].NCSCorrMgrList FM_GW_{—}1
   NCSCorrEntry[1].NCSCorrMgrList FM_GW_{—}3
   NCSCorrEntry[1].NCSCorrMgrList FM_GW_{—}5
   NCSCorrEntry[2]. Location east2 (a Site)
   NCSCorrEntry[2].NCSCorrMgrList FM_GW_{—}2
   NCSCorrEntry[2].NCSCorrMgrList FM_GW_{—}4
   NCSCorrEntry[2].NCSCorrMgrList FM_GW_{—}6

Although the invention has been described with respect to various embodiments, it should be realized this invention is also capable of a wide variety of further and other embodiments within the spirit of the invention.

It is claimed:

1. A system for correlating alarms from a plurality of network elements (nes) in a large communications network, comprising:
a plurality of alarm reporters that report alarms from the NEs when faults are detected; and
an alarm correlator processor that receives alerts from the plurality of alarm reporters, identifies in real-time if a received alert is valid for correlation processing, and reduces the number of alerts that the correlation must process.

2. A method of processing alert transactions for a network management system performing active correlations, comprising the steps of:
(a) receiving an alert transaction;
(b) normalizing a received alert transaction so as to extract characteristic information from the received alert transaction;
(c) matching the characteristic information to alert identifying criteria in non-duplicated entries of a data structure, each of the entries including the alert identifying criteria and a list of active correlation objects associated with the alert identifying criteria of that entry;
(d) if the characteristic information matches any of the alert identifying criteria of the entries, extracting a list of all active correlation objects associated with that entry, otherwise ceasing processing of the alert transaction;
(e) validating the alert transaction against internal matching criteria of the extracted active correlation objects until a validation match is located, thereby identifying the alert transaction as an active alert relevant to a particular extracted correlation object, otherwise ceasing processing of that active correlation object;
(f) performing actions depending upon the type of the validated alert transaction upon a valid alert list populated with alert transactions previously identified as active and relevant to the particular extracted correlation object that matches the validated alert transaction; and
(g) if the valid alert list is modified as a result of the actions of step (f), then executing the particular extracted correlation object upon the valid alert list associated with the particular extracted correlation object, otherwise ceasing processing of this correlation object.

3. The method of claim 2, wherein the results of executing the correlation object results in one or more effects upon a user interface display of a network monitoring station, the effects selected from the group consisting of generating a correlated root cause alert upon the occurrence of a pattern matching condition, clearing a correlated root cause alert upon the occurrence of a pattern matching condition, hiding one or more subordinate alerts upon the presence of a superior alert, unhiding one or more subordinate alerts upon the absence of a superior alert, and no effect.

4. The method of claim 2, wherein an operational state attribute of a correlation object influences the effects upon the user interface display.

5. The method of claim 2, wherein the alert identifying criteria comprises one or more criteria associated with a managed network element selected from the group consisting of regional information, site information, location of alert origin, manager class, manager, managed object, alert name, and alert description.

6. The method of claim 2, wherein the internal matching criteria comprise one or more regular expressions.

7. The method of claim 2, wherein each alert correlation object is user-defined.

8. The method of claim 2, wherein the performing step comprises:
if the validated alert transaction is of a ‘new’ alert type, adding the alert to the stored valid alert list;
if the validated alert transaction is of a ‘clear’ alert type, removing an alert the validated alert transaction is intended to clear from the valid alert list, if such an alert is present in the valid alert list; and
if the validated alert transaction is of an ‘update’ alert type, updating alert description information of an alert in the valid alert list the validated alert transaction is intended to update if such an alert is present in the valid alert list.

9. The method of claim 2, further comprising the step of repeating steps (a) through (f) on a large volume of alert transactions.

10. The method of claim 2, further comprising the step of populating one or more valid alert lists each uniquely associated with a corresponding one or more correlation objects, through the steps, performed for each of the one or more correlation objects, of:
compiling a full list of alerts matching any alert identifying criteria;
interrogating the full list of alerts against all matching criteria in the correlation object, thereby identifying all alerts relevant to the correlation object, and saving the alerts identified as relevant to the correlation object into a valid alert list uniquely associated with the correlation object.

11. The method of claim 10, further comprising the step of populating the entries of a data structure, each entry including a unique alert identifying criteria for which any match was found and a list of active correlation objects associated with that alert identifying criteria, excluding disabled correlation objects.

12. A correlation processor for use in a network management system performing active correlations of alert transactions received from managed network objects, comprising:
a memory for storing a valid alert list; and
a processor in communication with the managed network objects, the processor adapted to execute the steps of:
(a) receiving an alert transaction;
(b) normalizing the received alert transaction so as to extract characteristic information from the received alert transaction;
(c) matching the characteristic information to alert identifying criteria in non-duplicated entries of a data structure, each of the entries including the alert identifying criteria and a list of active correlation objects associated with the alert identifying criteria of that entry;
(d) if the characteristic information matches any of the alert identifying criteria of the entries, extracting a list of all active correlation objects associated with that entry, otherwise ceasing processing of the alert transaction;
(e) validating the alert transaction against internal matching criteria of the extracted active correlation objects until a validation match is located, thereby identifying the alert transaction as an active alert relevant to a particular extracted correlation object, otherwise ceasing processing of that active correlation object;
(f) performing actions depending upon the type of the validated alert transaction upon the valid alert list, the valid alert list populated with alert transactions previously identified as active and relevant to the particular extracted correlation object that matches the validated alert transaction; and
(g) if the valid alert list is modified as a result of the actions of step (f), then executing the particular extracted correlation object upon the valid alert list associated with the particular extracted correlation object, otherwise ceasing processing of this correlation object.

13. The correlation processor of claim 12, wherein the results of executing the correlation object results in one or more effects upon a user interface display of a network monitoring station, the effects selected from the group consisting of generating a correlated root cause alert upon the occurrence of a pattern matching condition, clearing a correlated root cause alert upon the occurrence of a pattern matching condition, hiding one or more subordinate alerts upon the presence of a superior alert, unhiding one or more subordinate alerts upon the absence of a superior alert, and no effect.

14. The correlation processor of claim 13, wherein an operational state attribute of a correlation object influences the effects upon the user interface display.

15. The correlation processor of claim 12, wherein the alert identifying criteria comprises one or more criteria associated with a managed network element selected from the group consisting of regional information, site information, location of alert origin, manager class, manager, managed object, alert name, and alert description.

16. The correlation processor of claim 12, wherein the internal matching criteria comprise one or more regular expressions.

17. The correlation processor of claim 12, wherein each alert correlation object is user-defined.

18. The correlation processor of claim 12, wherein the performing step executed by the processor further comprises:
if the validated alert transaction is of a ‘new’ alert type, adding the alert to the stored valid alert list;
if the validated alert transaction is of a ‘clear’ alert type, removing an alert the validated alert transaction is intended to clear from the valid alert list, if such an alert is present in the valid alert list; and
if the validated alert transaction is of an ‘update’ alert type, updating alert description information of an alert in the valid alert list the validated alert transaction is intended to update if such an alert is present in the valid alert list.

19. The correlation processor of claim 12, wherein the processor is further adapted to repeatedly execute the steps (a) through (f) on a large volume of alert transactions.

20. The correlation processor of claim 21, wherein the processor is further adapted to populate one or more valid alert lists each uniquely associated with a corresponding one or more correlation objects, through execution of the steps, performed for each of the one or more correlation objects, of:
compiling a full list of alerts matching any alert identifying criteria;
interrogating the full list of alerts against all matching criteria in the correlation object, thereby identifying all alerts relevant to the correlation object, and saving the alerts identified as relevant to the correlation object into a valid alert list uniquely associated with the correlation object.

21. The correlation processor of claim 20, wherein the processor is further adapted to execute the step of populating the entries of a data structure stored in the memory, each entry including a unique alert identifying criteria for which any match was found and a list of active correlation objects associated with that alert identifying criteria, excluding disabled correlation objects.
